(19) United States
(12) Patent Application Publication
(10) Pub. No.: US 2004/0192367 A1
(43) Pub. Date: Sep. 30, 2004

(54) Dispatch call "cut-in" alert

(76) Inventors: Mark A. Barros, Wellington, FL (US); Rami C. Levy, Plantation, FL (US)

Correspondence Address: MOTOROLA, INC., 1303 EAST ALGONQUIN ROAD, IL01/3RD, SCHAUMBURG, IL, 60196

(21) Appl. No.: 10/396,637

(22) Filed: Mar. 25, 2003

(51) Int. Cl. H04Q 7/20

(52) U.S. Cl. 455/521; 455/414.1

(57) ABSTRACT

A method for providing a cut-in alert includes the steps of storing the dispatch ID of the other party involved in a dispatch call (308). If the dispatch channel has been inactive for a predetermined period of time (314) and a new dispatch call is established (324) because of the inactivity, the radio then compares the dispatch ID previously stored with the dispatch ID of the telephone involved in the new dispatch call, if the ID's are different, a cut-in alert is provided to the user (330). The cut-in alert helps the telephone user avoid mistakenly thinking he is still communicating with the previous person he was involved in the dispatch call with. A communication device (520) is also described that provides the cut-in alert feature.

### TECHNICAL FIELD

This invention relates in general to the field of radio communications, and more specifically to a method and apparatus for providing a dispatch call “cut-in” alert.

### BACKGROUND

The dispatch communication mode provided by a wireless communication system such as the Integrated Digital Enhanced Network (iDEN®) radio communication system manufactured by Motorola, Inc. provides for extended range Push-To-Talk (PTT) capability by utilizing cellular technology to link two or more users within a group or fleet. The dispatch mode brings “walkie-talkie” like functionality to a cellular telephone, and is a very popular feature for certain markets such as law enforcement, construction, taxi dispatch, etc. Dispatch call mode is typically provided as an added feature for a nominal fee or provided as part of a service package to most users.

Dispatch call service is achieved by providing less bandwidth for the dispatch calls by using a higher speech compression ratio (e.g., 6:1) as compared to the lower compression ratio (e.g., 3:1) used for conventional cellular interconnect calls. Dispatch calls can also be actively terminated by the system if there is a predetermined period of inactivity by the dispatch call participants, thereby making system resources available to other users. These are compromises users are willing to accept for the advantages provided by the simple PTT dispatch service.

During a private dispatch call, the dispatch call participants communicate on a half duplex channel, taking turns talking and listening to each other. In the event that a user does not respond within a predetermined period of time, such as six seconds after the last transmission, the traffic channel reserved for the current dispatch conversation is lost (system deactivates the traffic channel) and must be re-established by the dispatch call participants.

A problem that is occasionally experienced under the aforementioned circumstance is what is referred to as “cut-in”. Cut-in is what happens when a third person attempts to set up a dispatch call with one of the two people engaged in the private dispatch call. Under normal circumstances, the third party is notified that the user he or she is trying to set up a dispatch call with is busy, also referred to as private busy. In some situations, dispatch call participants do not realize that the traffic channel they were using has been lost due to inactivity allowing for a third person to cut-in. This is extremely disruptive and disorienting to the existing conversation, as this cut-in is performed without warning to the dispatch call participants.

In FIG. 1, there is shown a prior art dispatch call traffic flow pattern. User 1 is engaged in a conversation with user 2 as shown in traffic flows 102 and 104. Users 1 and 2 in step 106 cause the dispatch call traffic channel to be released due to inactivity over a predetermined period of time, however both parties are still actively engaged in the conversation. For example, user 1 may be waiting for an answer from user 2 which may have caused the inactivity.

In traffic flow 108, user 3 successfully establishes a dispatch call with user 2, while user 2 still thinks he is involved in the dispatch call with user 1. In traffic flow 110, user 2 erroneously responds to user 3 thinking the response is directed to user 1. This of course causes confusion and loss of valuable time for the dispatch call participants as well as wastes the valuable system resources needed to establish a dispatch call. Given the above dispatch call cut-in problem, a need exists in the art for a method and apparatus that can alleviate the dispatch call cut-in problem.

### BRIEF DESCRIPTION OF THE DRAWINGS

The features of the present invention, which are believed to be novel, are set forth with particularity in the appended claims. The invention, may best be understood by reference to the following description, taken in conjunction with the accompanying drawings, in the several figures of which like reference numerals identify like elements, and in which:

FIG. 1 shows a prior art dispatch call sequence.

FIG. 2 shows a dispatch call sequence in accordance with an embodiment of the invention.

FIG. 3 shows a dispatch “cut-in” alert flow chart for outgoing calls in accordance with an embodiment of the invention.

FIG. 4 shows a dispatch “cut-in” alert flow chart for incoming calls in accordance with an embodiment of the invention.

FIG. 5 shows a wireless communication system in accordance with an embodiment of the invention.

FIG. 6 shows a communication device in accordance with an embodiment of the invention.

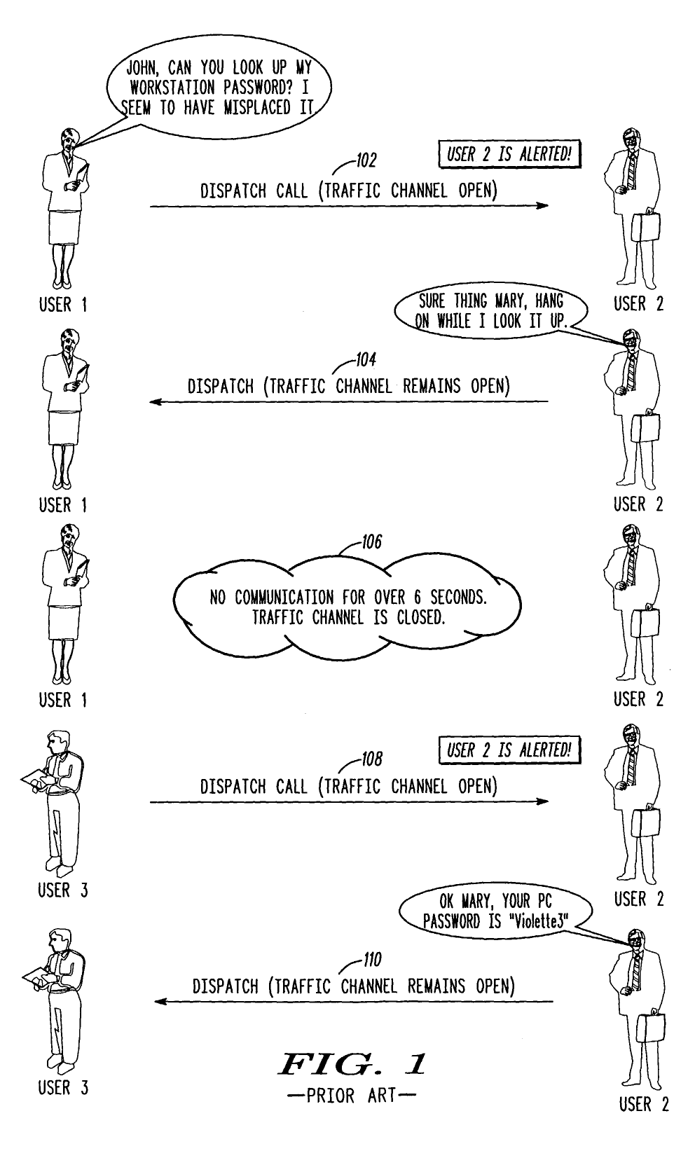

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures.

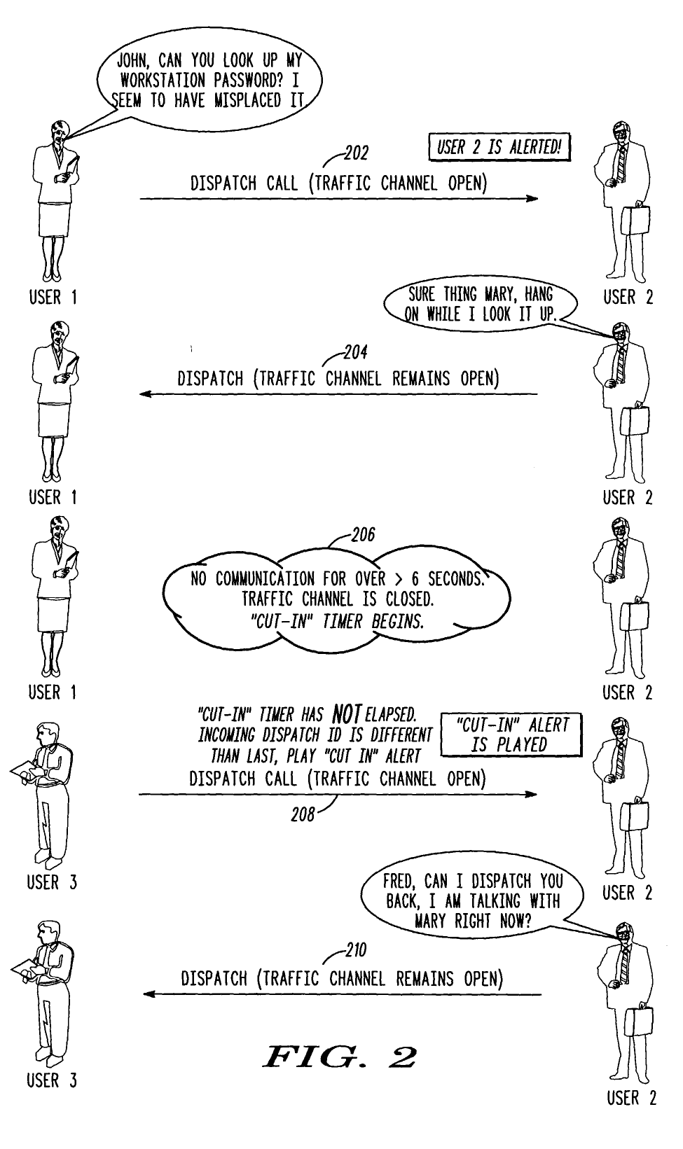

Referring now to FIG. 2, there is shown a dispatch call sequence in accordance with the invention. In traffic flows 202 and 204, users 1 and 2 are engaged in a dispatch call. In 206, the dispatch channel is released by the system due to inactivity for a predetermined period of time; however, both users are still actively engaged in the dispatch call. For example, user 1 might be waiting for an answer from user 2 to a question he asked. In traffic flow 208, user 3 successfully establishes a dispatch call with user 2. User 2's communication device notes that the dispatch ID received (e.g., User 3's ID) is different than the one used in the last dispatch call (e.g., User 1's ID) transmission. Additionally, a timed threshold (e.g., set at two minutes) since the traffic channel was released has not been exceeded. User 2 in accordance with an embodiment of the invention is provided with a cut-in alert signaling the arrival of a different dispatch call. As a result, user 2 does not respond to user 3 with information that was intended for user 1, but responds to user 3 knowing he is no longer communicating with user 1. The cut-in alert can take the form of an audio, visual and/or vibratory alert provided by user 2's telephone.

By recording the dispatch ID of the user a communication device is currently communicating with, the communication device can use a timed threshold to determine when dispatch call cut-ins occur, and properly alert the user. The timer, hereinafter referred to as a cut-in timer, begins counting down as soon as the traffic channel is released from the current dispatch call. If a user is dispatched while the cut-in timer is counting down, a dispatch ID comparison will take place. If the dispatch ID of the caller is different than that of the last dispatch call transmission, the recipient is presented with a unique alert and/or indication. This alert as mentioned previously can take the form of a unique audio tone sequence, vibration of the communication device, visual alert (e.g., flashing light), etc.

The cut-in alert signals the arrival of a dispatch call from a user different than the last one. The new caller's ID is stored, the cut-in timer is reset, and the process is repeated once the traffic channel is again released. If the dispatch ID received is the same as the previous call, the cut-in timer is reset and the normal dispatch alert is provided (e.g., a predetermined tone or sequence of tones). Finally, if the cut-in timer has elapsed when the new dispatch call is received, the normal dispatch alert is also provided.

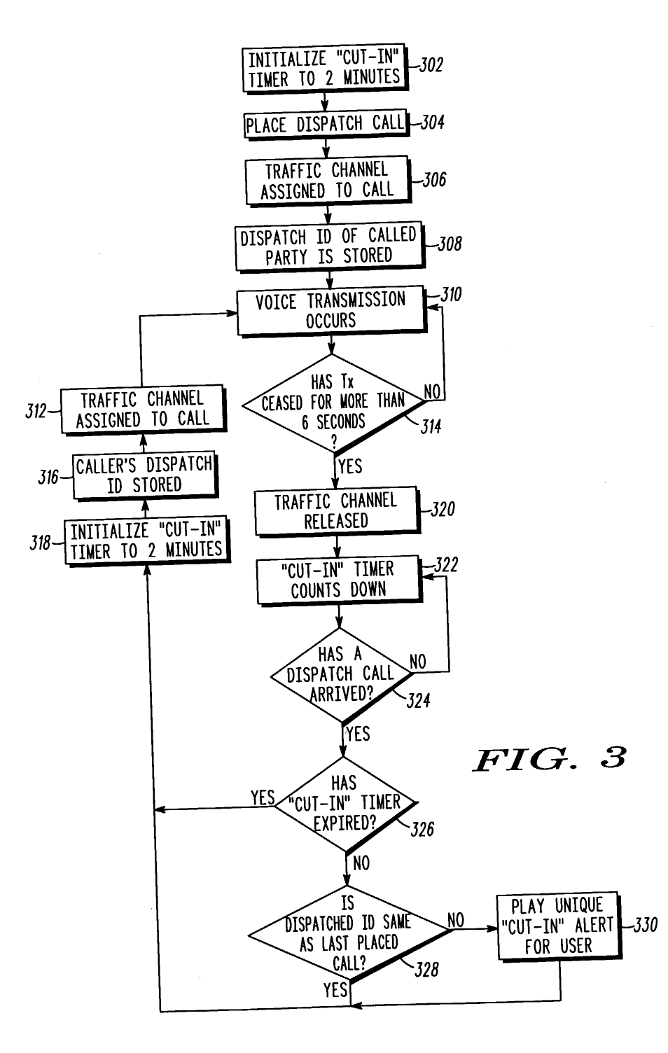

In FIG. 3 there is shown a dispatch cut-in alert process flow for the situation were the telephone in question is placing an outgoing dispatch call. In step 302, the cut-in timer is initialized for a predetermined period of time. In this illustrative example, the cut-in timer is initialized for two minutes. In step 304, the communication device places a dispatch call to another party. A traffic channel is assigned by the system for the dispatch call in step 306. In step 308, the dispatch ID of the called party is stored in the communication device. One of the dispatch call participants commences voice transmission in step 310.

In decision step 314 it is determined if the dispatch channel has been inactive for a predetermined period of time, in this example six seconds. If the dispatch channel has not been inactive for six seconds, the routine returns to step 310 and allows the dispatch call to continue. If the dispatch channel has been inactive for more than six seconds, the traffic channel is released in step 320. In step 322, the cut-in timer commences counting down (or counting up in a different design). In decision step 324, it is determined if a dispatch call has been received, if it has not, the routine loops back to step 322. If it is determined in step 324 that a dispatch call has been received, the routine moves to decision step 326 where it is determined if the cut-in timer has expired. If it has not, the routine in decision step 328 determines if the dispatch ID of the unit generating the dispatch call is the same as the ID of the unit participating in the previous dispatch call. If it is determined in step 328, that the dispatch IDs are different, in step 330, a unique cut-in alert is played to alert the user of the dispatch call cut-in situation. The cut-in alert can take the form of a unique audio alert, although other types of alerts such as visual (e.g., flashing light, etc.) and/or vibratory alerts can also be provided.

If in either decision step 326 it is determined that the cut-in timer has expired, or in decision step 328 it is determined that the dispatch ID is the same as the last ID, the routine moves to step 318 where the cut-in timer is initialized again. In step 316 the caller's dispatch ID is stored, and in step 312, a traffic channel is assigned to the call prior to the routine returning to step 310.

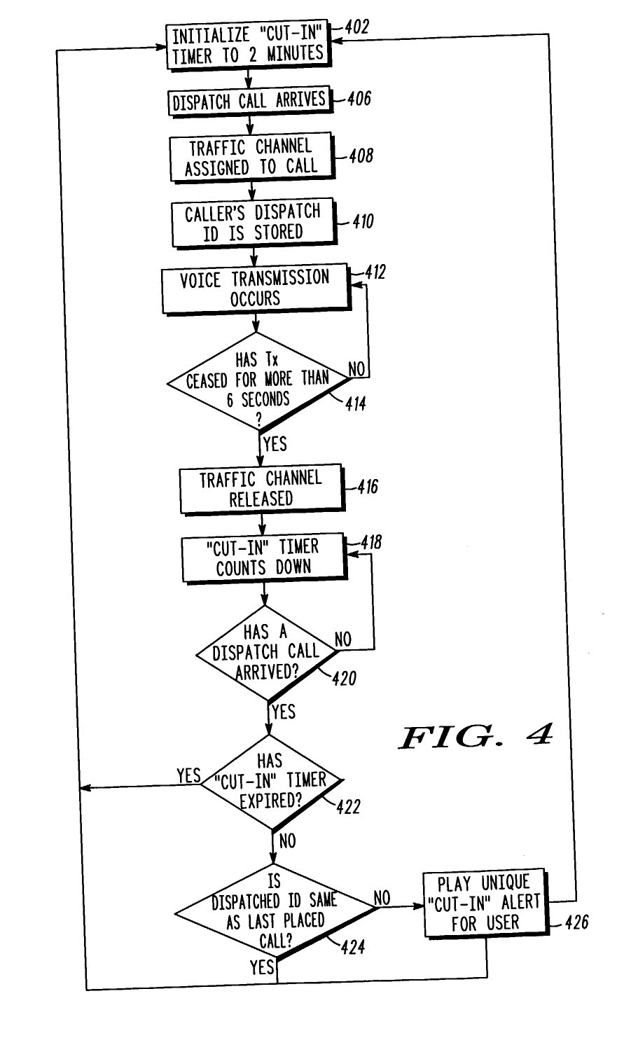

Referring now to FIG. 4, there is shown a process flow for incoming dispatch calls originating form another telephone. In step 402, the cut-in timer is initialized, for example, for two minutes at the same time the dispatch call arrives in step 406. In step 408, the communication system assigns a traffic channel to the dispatch call. In step 410, the caller's dispatch ID is stored in the communication device and voice communications commence in step 412. In decision step 414 it is determined if the dispatch call has been inactive for a predetermined period of time such as six minutes. If the dispatch call has not been inactive for the predetermined period of time, the routine returns to step 412 and the dispatch call traffic channel remains assigned to the dispatch call participants allowing them to continue with their conversation.

However, if in decision step 414 it is determined that the dispatch call has been inactive for the predetermined period of time (e.g., two minutes), the routine moves to step 416 where the traffic channel is automatically released by the communication system. In step 418, the cut-in timer commences to count down and in decision step 420 it is determined if another dispatch call has been received. If no new dispatch call has arrived, the routine loops back to step 418. However, if in step 420 it is determined that a new dispatch call has been received, the routine moves to decision step 422 which determines if the cut-in timer has expired.

If the cut-in timer has not expired, the routine in step 424 determines if the dispatch ID of the telephone involved in this dispatch call is the same as the last call. If it is not, in step 426 a cut-in alert is played for the user alerting him of the new dispatch call participant, and the routine returns to step 402. If in step 422 it is determined that the cut-in timer has expired, or in step 424 it is determined that the dispatch ID is the same as the last dispatch ID, the routine loops back to step 402.

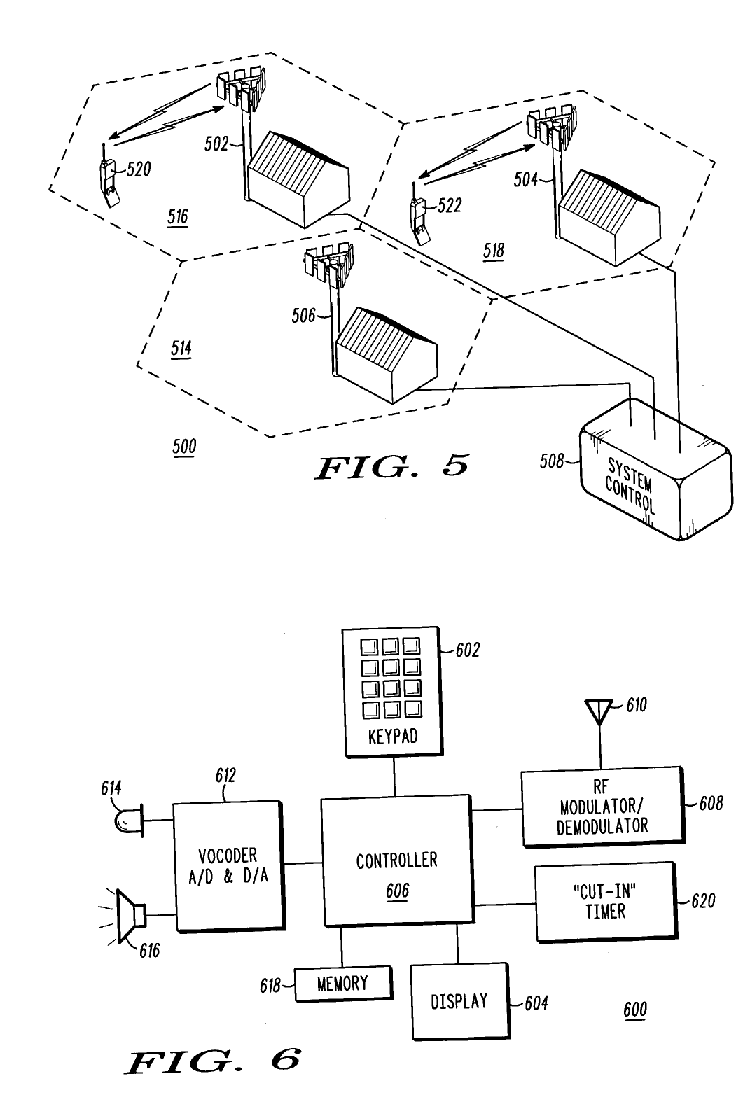

Referring now to FIG. 5, there is shown a communication system such as an iDEN® wireless communication system 500 in accordance with the invention. Communication system 500 includes a plurality of cell sites 502, 504 and 506 having their respective coverage areas 516, 518 and 514. A conventional system control 508 provides overall control of the system and provides the necessary coordination between cell sites 502, 504, 506, radio communication devices 520 and 522 and the Public Switched Telephone Network (PSTN, not shown). System Control 508 includes all the necessary infrastructure equipment used in a typical iDEN® system. A pair of radio communication devices or cellular telephones 520 and 522 having dispatch capability, operate within the system 500 and are designed to include the necessary hardware and/or software to perform the cut-in alert feature described previously. Although an iDEN® system is shown, any type of radio communication system that provides a dispatch feature can be used with the present invention.

In FIG. 6, there is shown a simplified block diagram of a communication device 600 like communication devices 520 and 522. A controller 606 such as a microprocessor or digital signal processor provides all of the necessary control function necessary to control the communication device as well as perform the dispatch cut-in routines previously mentioned. A conventional radio frequency (RF) modulator and demodulator section (RF receiver/transmitter section) 608 under the control of controller 606 handles the front-end RF functions. A Vocoder and analog-to-digital (AID) and digital-to-analog (D/A) circuitry block 612 provides all of the necessary audio processing for both incoming and outgoing voice traffic. Coupled to vocoder block 612 is a microphone 614 and speaker 616. In the present invention, the cut-in alert can be a distinct audio signal generated by controller 606 that is presented to the user via speaker 616.

A keypad or keyboard 602 is also provided to allow the user to enter data into the communication device. A display 604 provides the necessary visual information to the communication device user. A memory 618 is provided for use in storing radio data such as the dispatch ID information previously discussed. A cut-in timer 620 under the control of controller 606 provides the necessary timer function necessary for the present invention. Cut-in timer 620 can be implemented in hardware and/or software or a combination of the two. For example, cut-in timer can be a software routine executed by controller 606.

By recording the dispatch ID of the user a radio communication device is currently communicating with, the communication device 522 can use a timed threshold to determine when cut-ins to the dispatch call occur. If a dispatch call cut-in occurs, a distinct alert can be provided to alert the user that the dispatch call has been established with another user. This helps avoid the user from mistakenly thinking he is still involved in a communication with a party that is no longer involved in the dispatch call.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims. For example, although the preferred embodiment has discussed in view of dispatch calls between only two parties, more than two participants can be involved in the dispatch calls and the present invention can still be applicable.

What is claimed is:

1. A method for providing a dispatch call cut-in alert at a first radio communication device, comprising the steps of:
(a) establishing a dispatch call between the first radio communication device and at least a second radio communication device;
(b) storing at the first radio communication device an identification (ID) of the second radio communication device;
(c) determining if another dispatch call with a radio communication device has been established; and
(d) comparing the ID stored in step (b) for the second radio communication device with an ID of the radio communication device establishing the dispatch call in step (c); and
(e) providing a cut-in alert at the first radio communication device if in step (d) it is determined that the IDs do not match.

2. A method as defined in claim 1, wherein the cut-in alert of step (e) comprises an audio, visual and/or vibratory alert.

3. A method as defined in claim 1, wherein step (c) does not occur unless a traffic channel used for the dispatch call established in step (a) has been released due to inactivity.

4. A method as defined in claim 3, further comprising the step of:
(f) commencing a cut-in timer at the first radio communication device once the traffic channel used for the dispatch call established in step (a) is released.

5. A method as defined in claim 4, wherein the cut-in alert of step (e) is not performed if the cut-in timer expires prior to establishing the new dispatch call of step (c).

6. A method as defined in claim 1, wherein the first communication device comprises a radio communication device that can operate within an Integrated Digital Enhanced Network system.

7. A method as defined in claim 1, wherein the cut-in alert comprises a distinct audio signal that informs the user of the first radio communication device that the dispatch call established in step (a) is no longer active and that the first communication device is no longer communicating with the second radio communication device.

8. A method for providing an alert to the user of a first communication device involved in a dispatch call with a second communication device when a cut-in to the dispatch call occurs, comprising the steps of:
(a) storing an ID of the second communication device;
(b) starting a cut-in timer once a traffic channel assigned to the dispatch call has been released;
(c) determining if the first communication device is part of a new dispatch call; and
(d) comparing the ID stored in step (a) with the ID of a radio communication device establishing the dispatch call of step (c).

9. A method as defined in claim 8, further comprising the step of:
(e) providing a cut-in alert at the first radio communication device if in step (d) it is determined that the IDs do not match.

10. A method as defined in claim 9, wherein prior to performing step (e) it is determined if the cut-in timer has expired.

11. A method as defined in claim 10, wherein if the cut-in timer has expired, step (e) is not performed.

12. A method as defined in claim 11, wherein if the cut-in timer has expired, the cut-in timer is reinitialized and the ID of the radio communication device establishing the dispatch call of step (c) is stored.

13. A method as defined in claim 9, wherein the cut-in alert comprises an audio, visual and/or vibratory alert.

14. A method as defined in claim 9, wherein the cut-in alert comprises a unique audio alert that alerts the user of the first radio communication device that a cut-in to the dispatch call with the second radio communication device has occurred.

15. A radio communication device operable in a communication system that allows for dispatch calls between two or more radio communication device, the radio communication device comprising:
a radio frequency receiver and transmitter section for receiving and transmitting messages;
a controller coupled to the radio frequency receiver and transmitter section;
a memory coupled to the controller; and
the controller in response to the radio communication device establishing a dispatch call with a second radio communication device, storing in the memory the ID of the second radio communication device and comparing this ID to the ID of any radio communication device establishing a subsequent dispatch call with the radio communication device.

16. A radio communication device as defined in claim 15, wherein the controller generates a cut-in alert if the IDs compared by the controller do not match.

17. A radio communication device as defined in claim 16, wherein the cut-in alert is not generated if a predetermined period of time has elapsed between the original dispatch call and the subsequent dispatch call.

18. A radio communication device as defined in claim 15, wherein the controller provides for a cut-in timer that starts counting when the communication channel used for the dispatch call with the second communication device is released.

19. A radio communication device as defined in claim 18, wherein if the cut-in timer has not reached a predetermined limit and the IDs compared by the controller do not match, the controller generates a cut-in alert.

20. A radio communication device as defined in claim 19, wherein the radio communication device further comprises a speaker coupled to the controller, and the cut-in alert comprises a distinct audio alert.
